(19) United States
(12) Patent Application Publication
(10) Pub. No.: US 2022/0172160 A1
(43) Pub. Date: Jun. 2, 2022

(54) TRUCK LOAD INFORMATION SYSTEM

(71) Applicant: Scully Signal Company, Wilmington, MA (US)

(72) Inventors: Robert McGonagle, Wilmington, MA (US); Steven Ent, Wilmington, MA (US); Brian Marshall, Wilmington, MA (US); Rohan Verma, Wilmington, MA (US); James Carrington, Wilmington, MA (US)

(73) Assignee: Scully Signal Company, Wilmington, MA (US)

(21) Appl. No.: 17/442,522

(22) PCT Filed: Mar. 24, 2020
(86) PCT No.: PCT/US2020/024425

§ 371 Date: Sep. 23, 2021

Related U.S. Application Data
(60) Provisional application No. 62/823,263, filed on Mar. 25, 2019.

(51) Int. Cl. G06Q 10/08; B60P 3/22

(52) U.S. Cl. CPC G06Q 10/0832; B60P 3/228

(57) ABSTRACT

A method and system for controlling a transfer of liquid from or to a transport vehicle uses a memory module on the vehicle to keep track of vehicle parameters. When a transfer request, having a plurality of transfer parameters, is received, transport vehicle parameters representative of a current condition of the transport vehicle are retrieved. The transfer parameters are compared to the transport vehicle parameters. The transfer proceeds as a result of determining that each comparison of a transfer parameter to a transport vehicle parameter is correct.

### CROSS-REFERENCE TO RELATED APPLICATION

This application claims priority to U.S. Provisional Patent Application No. 62/823,263 entitled “Truck Load Information System,” filed on Mar. 25, 2019 which is hereby incorporated by reference in its entirety for all purposes.

### BACKGROUND

Different types of fuel or petroleum products may be distributed from the same point and the tanker trucks that receive these products may carry different types, or grades, of fuel at the same time. Of course, each fuel is kept in its own respective compartment as the mixing, or cross-contamination, of different fuels can be dangerous.

Fuel contamination may occur during the time a tanker truck is being loaded, although the goal is to place the correct fuel should in the appropriate compartment and when the delivery, or unloading, is performed, the fuel needs to be placed in the correct receiving compartment. It is, therefore, imperative that “cross-drop” or “cross-over” situations be avoided as this contamination negatively impacts inventory, billing and safety.

Systems are known for preventing the contamination of fuels in both the loading and unloading of fuel transport vehicles. What is needed, however, is an improved system for doing so.

### SUMMARY

In one aspect of the present disclosure there is a system comprising a processor and a memory configured to store a plurality of instructions executable by the processor to implement a method of controlling a transfer of liquid from, or to, a transport vehicle. The method comprises: retrieving, from a memory module on the transport vehicle, a plurality of transport vehicle parameters representative of a current condition of the transport vehicle; receiving a requested liquid transfer request having a plurality of transfer parameters; comparing one or more of the transfer parameters to one or more of the transport vehicle parameters; proceeding with the transfer as a result of determining compliance if each comparison of a transfer parameter to a transport vehicle parameter is determined to be correct; and upon completion of the transfer, updating one or more of the transport vehicle parameters to reflect a current status of the respective parameter due to completion of the transfer.

In another aspect of the present disclosure there is a method of controlling a transfer of liquid from, or to, a transport vehicle, comprising: retrieving, from a memory module on the transport vehicle, a plurality of transport vehicle parameters representative of a current condition of the transport vehicle; receiving a requested liquid transfer request having a plurality of transfer parameters; comparing one or more of the transfer parameters to one or more of the transport vehicle parameters; proceeding with the transfer as a result of determining compliance if each comparison of a transfer parameter to a transport vehicle parameter is determined to be correct; and upon completion of the transfer, updating one or more of the transport vehicle parameters to reflect a current status of the respective parameter due to completion of the transfer.

The transport vehicle parameters comprise one or more of: a volume of liquid loaded into a respective vehicle compartment Cx, where x=1 to N, with N being the number of compartments, a type of liquid loaded in the compartment Cx, name, address, gantry number, and/or Loading Controller ID information regarding a loading station that provided the liquid in the compartment Cx, a date/time stamp identifying when the liquid was loaded into the compartment Cx, an expiration date of a Vapor Inspection Certificate, an expiration date of a safe loading pass, an expiration date of a user-specified certification, and a current overfill sensor count compared with as-built data.

In one aspect of the present disclosure, the method further comprises comparing each of the transfer parameters to a transport vehicle parameter.

In another aspect, the method further comprises comparing each of the transport vehicle parameters to a transfer parameter.

### BRIEF DESCRIPTION OF THE DRAWINGS

Various implementations of at least one aspect of the present disclosure are discussed below with reference to the accompanying figures. It will be appreciated that for simplicity and clarity of illustration, elements shown in the drawings have not necessarily been drawn accurately or to scale. Further, where considered appropriate, reference numerals may be repeated among the drawings to indicate corresponding or analogous elements. For purposes of clarity, not every component may be labeled in every drawing. The figures are provided for the purposes of illustration and explanation and are not intended as a definition of any limits of aspects of the present disclosure. In the figures:

FIG. 1 is a block diagram of a system in accordance with an aspect of the present disclosure;

FIG. 2 is a representative listing of information recorded in a memory module in accordance with an aspect of the present disclosure;

FIG. 3 is a flowchart of a method in accordance with an aspect of the present disclosure; and

FIG. 4 is a functional block diagram of an aspect of the present disclosure.

### DETAILED DESCRIPTION

This application claims priority to U.S. Provisional Patent Application No. 62/823,263 entitled “Truck Load Information System,” filed on Mar. 25, 2019 which is hereby incorporated by reference in its entirety for all purposes.

In the following detailed description, numerous specific details are set forth in order to provide a thorough understanding of the aspects of the present disclosure. It will be understood by those of ordinary skill in the art that these may be practiced without some of these specific details. In other instances, well-known methods, procedures, components and structures may not have been described in detail so as not to obscure the aspects of the present disclosure.

Prior to explaining at least one aspect of the present disclosure in detail, it is to be understood that these aspects of the present disclosure are not limited in their application to the details of construction and the arrangement of the components set forth in the following description or illustrated in the drawings. Other implementations are possible. Also, it is to be understood that the phraseology and terminology employed herein are for description only and should not be regarded as limiting.

It is appreciated that certain features, which are, for clarity, described in the context of separate implementations, may also be provided in combination in a single implementation. Conversely, various features, which are, for brevity, described in the context of a single implementation, may also be provided separately or in any suitable sub-combination.

Generally, aspects of the present disclosure are directed to reducing the chances that a driver or operator places a petroleum product into either the incorrect storage tank or tanker truck compartment.

Accordingly, aspects of the present disclosure improve efficiency and reduce errors in the transport of liquids via tank truck by providing a Truck Load Information (TLI) System. The TLI System includes a memory module that is mounted to the truck, and which is accessed by controllers at each loading and unloading station, as will be described below in more detail.

As is known, loading or unloading is permitted when: 1) the product on the tanker truck has been confirmed, e.g., correct product type, correct product grade and in the correct compartment; 2) the correct storage tank is identified and the product type and grade for the identified tank are confirmed and the same as the compartment from/to which product is to be transferred; and 3) the inventory system is correct and updated.

By way of some background, it is noted that the commercial truck carrier assumes the risk and costs for cross drops. The carrier, i.e., through the tanker truck operator, is tasked with ensuring that the right product is dispensed into the right compartment, regardless of whether this occurs during a terminal to tanker or tanker to retailer product transfer.

Petroleum fuel loading and unloading processes are manual and prone to human errors. Normal decision making is influenced by human conditions (distraction, boredom, illness), which can contribute to a cross drop occurrence. Currently, the carrier operator is equipped with informal processes (procedural, equipment, etc.) to mitigate this liability. Errors are a reality and the associated costs (potentially significant) are a part of doing business in the petroleum transport market sector.

In one known approach to controlling the loading/unloading process, a Loading Controller is connected to the tanker truck in order to monitor a set of overfill sensors and grounding equipment, as is described in U.S. Pat. No. 8,731,725, entitled “Truck Compartment Verification System With Alternate Truck ID,” to Trottier (Trottier '825) the entire contents of which is incorporated herein by reference. In addition, the loading controller accesses tanker truck specific information from a memory module provided on the truck, for example, the number of compartments, the capacity of each compartment, ID #of the truck, etc., in order to qualify the requested loading operation before allowing it.

The memory module in Trottier '825 is used to store “static” or unchanging status information about the tanker truck, for example, vehicle Builder Name and Address, vehicle Serial Number, vehicle VIN number, volume of each compartment, etc.

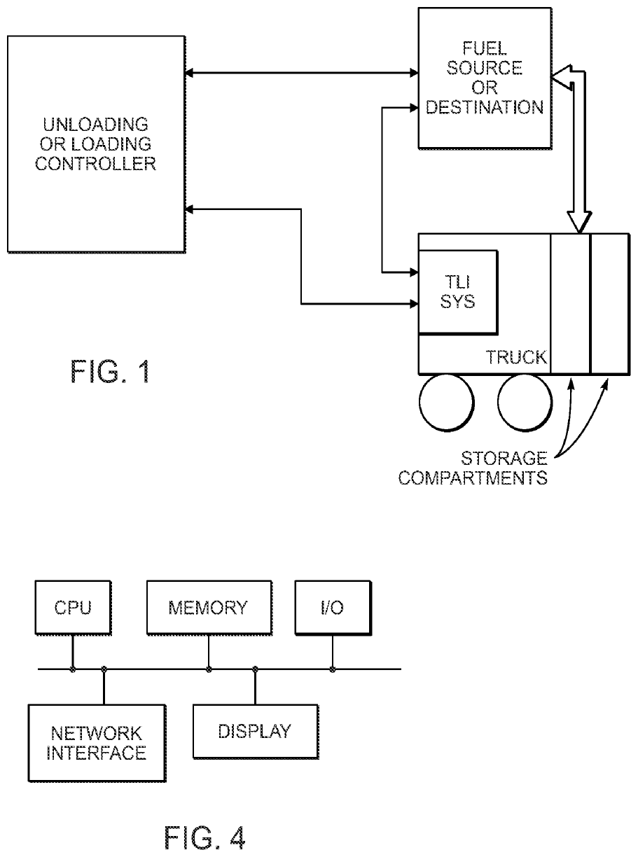

Aspects of the TLI System, as shown in FIG. 1, and described herein write “dynamic” status information about the current conditions of the truck into the truck's memory module. This stored information includes, but is not limited to, information about the liquids currently loaded onboard and the status of the safety system. This information is updated in the truck memory module when the truck is loaded and then accessed when an unloading process is started.

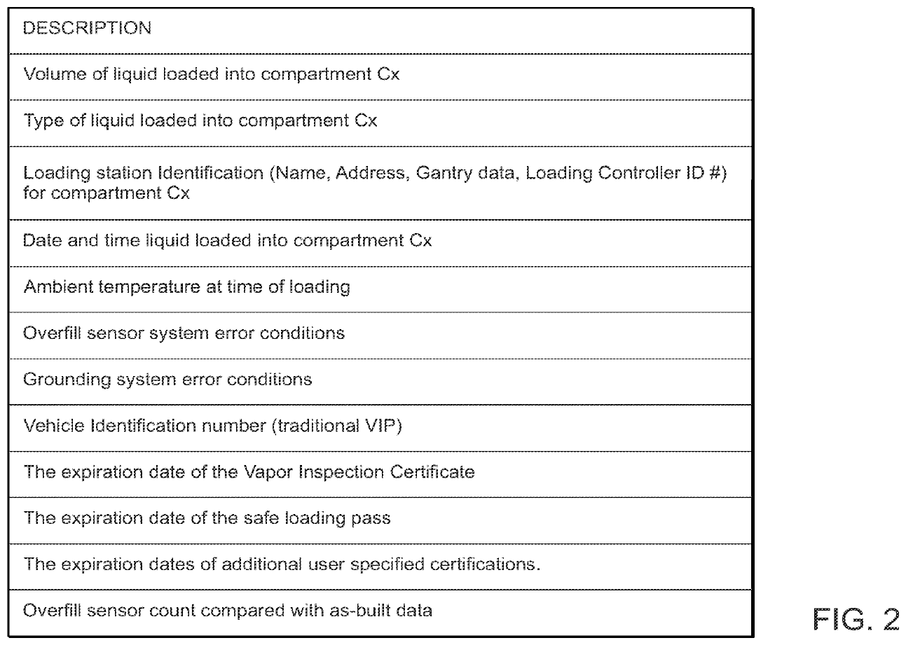

More specifically, dynamic information regarding the truck's contents is written to the memory module, as shown in FIG. 2, and can include, but is not limited to:

(a) The volume of liquid loaded into a respective compartment Cₓ, where x=1 to N, with N being the number of compartments,

(b) The type of liquid loaded in the compartment Cₓ,

(c) Information regarding the loading station that provided the liquid, e.g.,

Name, Address, gantry number, and/or Loading Controller ID in the compartment Cₓ,

(d) A date/time stamp identifying when the liquid was loaded into the compartment Cₓ,

(e) The expiration date of the Vapor Inspection Certificate,

(f) The expiration date of the safe loading pass,

(g) The expiration date of a user-specified certification,

(h) A current overfill sensor count compared with as-built data,

It should be noted that the information may be compartment specific in that, for example, liquid in one compartment may have been loaded by a first supplier on a first day at a first time while liquid loaded in another compartment may have been by a second supplier on a different, or the same day, and/or at a different time. In either event, the information for specific compartments is recorded, and identified as such, in the memory module.

In addition, any detected loading errors or equipment deficiencies with any of the truck control/safety systems, for example, the overfill sensors or grounding system, are recorded in a “fault log” that is also kept in the memory module.

Advantageously, at an unloading station, the Unloading Controller accesses the information from the memory module and uses this information to qualify, i.e., approve or allow, a requested transfer. For example, the retrieved information will be analyzed to ensure that the amount, type, and pedigree, i.e., age and source, meet any requirements set in place prior to allowing the unload or load operation to commence.

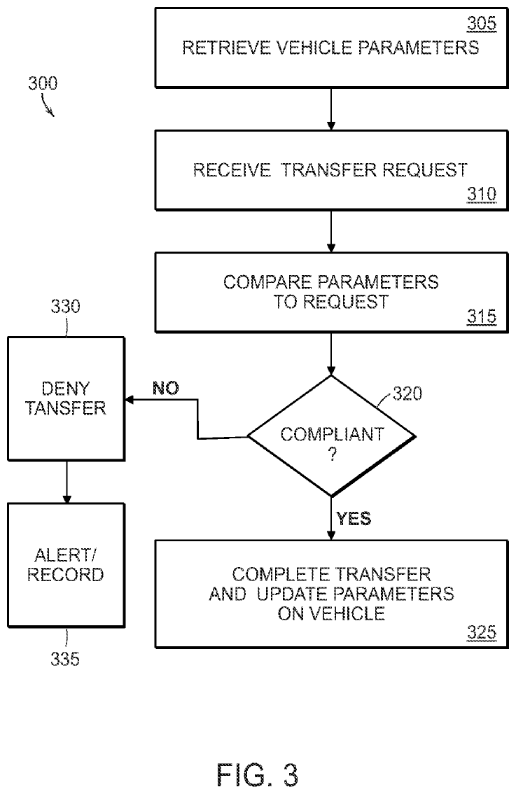

For example, referring to FIG. 3, a method 300 in accordance with an aspect of the present disclosure includes retrieving vehicle parameters, step 305, and receiving a transfer request, step 310. The sets of parameters are compared, step 315, and if determined compliant, e.g., matching, then control passes to step 325 to complete the transfer. When the transfer is completed, the vehicle parameters are updated to reflect the post-transfer condition. Returning to step 320, if there is no compliance, then control passes to step 330 and the transfer is denied. Subsequently, at step 335, an alert may be sent and/or the condition recorded.

As another non-limiting example, vehicle loading/unloading can be additionally authorized/denied based on:

(a) comparing load volume request to allowable compartment limits to assure that request is not exceeding capacity,

(b) comparing current temperature to allowable ambient loading temperature,

(c) comparing requested fuel type to designated compartment's fuel type,

(d) determining the age of the fuel based on when it was loaded and comparing to allowed age for type of fuel being processed.

In the event that a truck system error has been identified, for example, in the overfill sensors or grounding system, any loading/unloading controller that accesses the memory module would read the fault log and could identify the component in need of repair.

Advantageously, system troubleshooting of the overfill protection system is simplified as any loading faults, along with the terminal name, location, lane, last loading time, and load history are stored with the vehicle in the memory module. This information can be accessed using, for example, an authorized handheld reader, by terminal workers and service centers who can view this diagnostic information to pinpoint errors for troubleshooting and repair. In addition, a service center can log information regarding repairs, service times and safety system inspection certificate validity information.

Various implementations of the above-described systems and methods may be provided in digital electronic circuitry, in computer hardware, firmware, and/or software as shown and arranged in FIG. 4. The implementation can be as a computer program product, i.e., a computer program tangibly embodied in an information carrier. The implementation can, for example, be in a machine-readable storage device for execution by, or to control the operation of, data processing apparatus. The implementation can, for example, be a programmable processor, a computer, and/or multiple computers.

While some of the above-described implementations may generally depict a computer implemented system employing at least one processor executing program steps out of at least one memory to obtain the functions herein described, it should be recognized that the presently described methods may be implemented via the use of software, firmware or alternatively, implemented as a dedicated hardware solution such as in an application specific integrated circuit (ASIC) or via any other custom hardware implementation.

It is to be understood that various aspects of the present disclosure have been described using non-limiting detailed descriptions of implementations thereof that are provided by way of example only and are not intended to be limiting. Features and/or steps described with respect to one implementations may be used with others and not all have all of the features and/or steps shown in a particular figure or described with respect to one of the implementations. Variations will occur to persons of skill in the art.

It should be noted that some of the above described implementations include structure, acts or details of structures and acts that may not be essential and which are described as examples. Structure and/or acts described herein are replaceable by equivalents that perform the same function, even if the structure or acts are different, as known in the art, e.g., the use of multiple dedicated devices to carry out at least some of the functions described as being carried out by the processor.

What is claimed is:

1. A system comprising a processor and a memory configured to store a plurality of instructions executable by the processor to implement a method of controlling a transfer of liquid from, or to, a transport vehicle, the method comprising:
retrieving, from a memory module on the transport vehicle, a plurality of transport vehicle parameters representative of a current condition of the transport vehicle;
receiving a requested liquid transfer request having a plurality of transfer parameters;
comparing one or more of the transfer parameters to one or more of the transport vehicle parameters;
proceeding with the transfer as a result of determining compliance if each comparison of a transfer parameter to a transport vehicle parameter is determined to be correct; and
upon completion of the transfer, updating one or more of the transport vehicle parameters to reflect a current status of the respective parameter due to completion of the transfer.

2. The system of claim 1, wherein the transport vehicle parameters comprise one or more of:
a volume of liquid loaded into a respective vehicle compartment Cx, where x=1 to N, with N being the number of compartments,
a type of liquid loaded in the compartment Cx,
name, address, gantry number, and/or Loading Controller ID information regarding a loading station that provided the liquid in the compartment Cx,
a date/time stamp identifying when the liquid was loaded into the compartment Cx,
an expiration date of a Vapor Inspection Certificate,
an expiration date of a safe loading pass,
an expiration date of a user-specified certification, and
a current overfill sensor count compared with as-built data of the transport vehicle.

3. The system of claim 1, the method further comprising:
comparing each of the transfer parameters to a transport vehicle parameter.

4. The system of claim 1, the method further comprising:
comparing each of the transport vehicle parameters to a transfer parameter.

5. A method of controlling a transfer of liquid from, or to, a transport vehicle, comprising:
retrieving, from a memory module on the transport vehicle, a plurality of transport vehicle parameters representative of a current condition of the transport vehicle;
receiving a requested liquid transfer request having a plurality of transfer parameters;
comparing one or more of the transfer parameters to one or more of the transport vehicle parameters;
proceeding with the transfer as a result of determining compliance if each comparison of a transfer parameter to a transport vehicle parameter is determined to be correct; and
upon completion of the transfer, updating one or more of the transport vehicle parameters to reflect a current status of the respective parameter due to completion of the transfer.

6. The method of claim 5, wherein the transport vehicle parameters comprise one or more of:
a volume of liquid loaded into a respective vehicle compartment Cx, where x=1 to N, with N being the number of compartments,
a type of liquid loaded in the compartment Cx,
name, address, gantry number, and/or Loading Controller ID information regarding a loading station that provided the liquid in the compartment Cx,
a date/time stamp identifying when the liquid was loaded into the compartment Cx,
an expiration date of a Vapor Inspection Certificate,
an expiration date of a safe loading pass,
an expiration date of a user-specified certification, and
a current overfill sensor count compared with as-built data of the transport vehicle.

7. The method of claim 5, further comprising:
comparing each of the transfer parameters to a transport vehicle parameter.

8. The method of claim 5, further comprising:
comparing each of the transport vehicle parameters to a transfer parameter.

9. A method of controlling a transfer of liquid from, or to, a transport vehicle, comprising:
retrieving, from a memory module on the transport vehicle, a plurality of transport vehicle parameters representative of a current condition of the transport vehicle;
receiving a requested liquid transfer request having a plurality of transfer parameters;
comparing one or more of the transfer parameters to one or more of the transport vehicle parameters to determine compliance;
proceeding with the transfer as a result of determining compliance; and
upon completion of the transfer, updating one or more of the transport vehicle parameters to reflect a current status of the respective parameter due to completion of the transfer,
wherein the transport vehicle parameters comprise one or more of:
(a) a volume of liquid loaded into a respective vehicle compartment Cₓ, where x=1 to N, with N being the number of compartments,
(b) a type of liquid loaded in the compartment Cₓ,
(c) name, address, gantry number, and/or Loading Controller ID information regarding a loading station that provided the liquid in the compartment Cₓ,
(d) a date/time stamp identifying when the liquid was loaded into the compartment Cₓ,
(e) an expiration date of a Vapor Inspection Certificate,
(f) an expiration date of a safe loading pass,
(g) an expiration date of a user-specified certification, and
(h) a current overfill sensor count compared with as-built data.
